(19) United States
(12) Patent Application Publication
(10) Pub. No.: US 2006/0107288 A1
(43) Pub. Date: May 18, 2006

(54) Method of weeding out commercials by searching for the existence of key segments

(75) Inventors: Hochao Huang, Hsintien City (TW); Dueg-Uei Sheng, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Cyberlink Corp

(21) Appl. No.: 10/991,194

(22) Filed: Nov. 17, 2004

(51) Int. Cl. H04N 7/16; H04N 7/025; H04N 7/10

(52) U.S. Cl. 725/32; 725/135; 725/34

(57) ABSTRACT

A method for weeding out commercials by searching for the existence of key segments at the time the commercials are going to interrupt and resume a main program is provided. The method includes steps of receiving an input source, searching for a program interruption section and a program resumption section in the input source, marking a plurality of key segments in the input source corresponding to the program interruption section and the program resumption section, and finding a plurality of commercials between the key segments. Therefore, similar key segments can be automatically or manually searched so as to filter commercials in the program.

### BACKGROUND OF THE INVENTION

1. Field of the Invention

The present invention relates to a method for weeding out the commercials interrupting the main program by searching for the key segments in the main program, and more particularly, to a method for weeding out the commercials by taking advantage of characteristics of the key segments.

2. Descriptions of Prior Arts

Currently, for the continuing stay in the business, commercial providers would have a symbiotic relationship with TV program providers. They purchase a period of time from TV program providers for inserting commercials during the broadcasting of programs in exchange for the exposure of their products or services. These commercials usually accompany a message, such as “Please wait, we'll be right back” or “Welcome back”, shown before interrupting or resuming to the main program for indicating the interruption or the resumption of the main program.

Generally, the program-editing software adopts the technology of “scene detection” to tell the color differences in the program so as to find out different scenes in the program. However, the number of scenes in a single program is very large so that users have to check every specific scene if they want to have the “scene detection” tell the color differences. As the result the “scene detection” would be a time-consuming task.

From the standpoints of viewers, they probably would prefer programs without interruptions of the commercials at the time of watching them or recording the main programs having no commercials therein.

### SUMMARY OF THE INVENTION

It is therefore a primary objective of the present invention to provide a method of weeding out the commercials by searching for the key segments in the main programs.

In accordance with the claimed invention, a method for weeding out commercials by searching for the existence of key segments at the time the commercials are going to interrupt and resume a main program includes steps of receiving an input source; searching for a program interruption section and a program resumption section in the input source; marking a plurality of key segments in the input source corresponding to the program interruption section and the program resumption section; and finding a plurality of commercials between the key segments.

It is an advantage of the present invention that the commercials in the main program would be found out without too much effort by searching for the locations of key segments, such as key frames or key period of sounds. The program between these key segments would be the program without any commercials.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an operational flow chart illustrating a first embodiment of the present invention; and

FIG. 2 is an operational flow chart illustrating a second embodiment according to the present invention.

### DETAILED DESCRIPTION OF THE PREFERRED EMBODIMENT

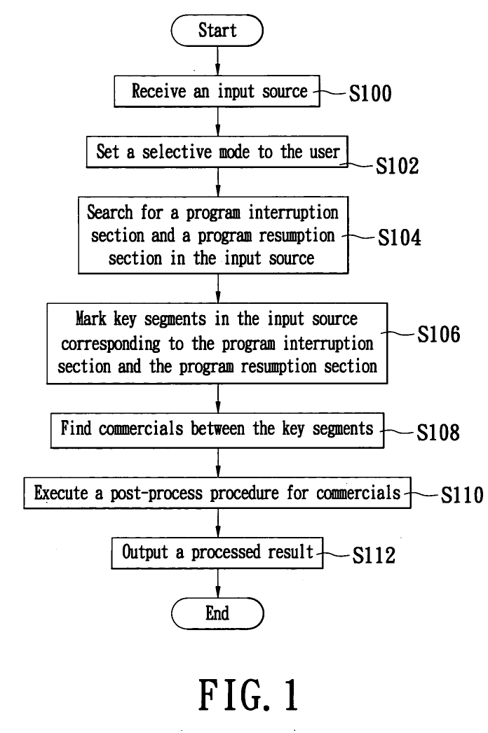

Please refer to FIG. 1 of an operational flow chart of a first embodiment according to the present invention. In this embodiment, the method of weeding out commercials by searching for the existence of key segments firstly receives an input source (S100). The input source preferably is either a movie film or a television program and the key segments would be repeated phrases or fixed frames, such as “Stay tuned, we will be right back” or “Welcome back”. Users would set a selective mode for searching these key segments (S102). The selective mode can be a manual or an automatic selective mode, wherein the automatic selective mode is implemented by executing a software program for automatically searching for these key segments.

Then the method would search for a program interruption section and a program resumption section in the input source according to the selective mode (S104). The program interruption section is a message before interrupting the main program, and the program resumption section is a message before resuming the main program. The program interruption section and the program resumption section are preferably frames, periods of sounds, or combinations of both frames and periods of sounds. Since each commercial consists of a video portion and an audio portion, a plurality of key segments in the input source could be marked according to the program interruption section and the program resumption section (S106). Also, key segments could be marked according to segments similar to the program interruption section and the program resumption section. Therefore, commercials would be found between each two key segments (S108), especially between one program interruption section and one program resumption section. Then, the present method executes a post-process procedure for commercials (S110) for outputting a processed result (S112). The post-process procedure is preferably to delete these commercials in this embodiment so as to output a commercial-free program or movie film; of course the post-process procedure can also be applied to store these commercials depending on user requirements.

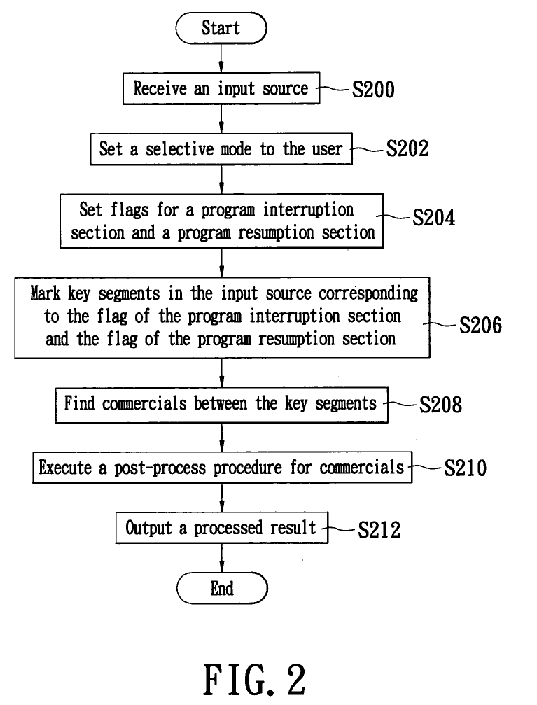

Please refer to FIG. 2 of an operational flow chart of a second embodiment of the present invention. In this embodiment, the method of weeding out commercials by searching for the existence of key segments firstly receives an input source (S200). The input source preferably is either a movie film or television program, and the key segments would be repeated phrases or fixed frames, such as “Stay tuned, we will be right back” or “Welcome back”. Users then set a selective mode provided in the present invention as a manual or an automatic one (S202) and the automatic selective mode would search for these key segments with the help of a software program.

Flags corresponding to the respective program interruption section and program resumption section with respect to the input source would be configured (S204). The program interruption section is a message before interrupting the main program, and the program resumption section is a message before resuming the main program. The program interruption section and the program resumption section are preferably frames, periods of sounds, or combinations of both frames and periods of sounds. Since each commercial consists of a video portion and an audio portion, a plurality of key segments in the input source could be marked according to the flag of the program interruption section and the flag of the program resumption section (S206). Also, key segments could be marked according to segments similar to the program interruption section and the program resumption section. Therefore, commercials would be found between each two key segments (S208), especially between one program interruption section and one program resumption section. Then, the present method executes a post-process procedure for commercials (S210) for outputting a processed result (S212). The post-process procedure is preferably to delete these commercials in this embodiment so as to output a commercial-free program or movie film; of course the post-process procedure can also be applied to store these commercials depending on user requirements.

The present invention weeds out the commercials by searching for the existences of key segments or existing at the time the commercials are going to interrupt or resume the main program. Two ways are disclosed to advance the same purpose in the present invention. The first one is to let users to set frame-marks (flags) at the time the commercials are going to interrupt the main program and the main program is going to continue again. The stuff between these frame-marks (flags) is supposed to be the commercials and thus could be filtered out without difficulties. An alternative to the first method would leave software to automatically detect the starting and finishing points and therefore users would view the consequences of the software detections and then mark the locations of program stopping and program-restarting by themselves. Thereafter the software will cut off these commercials between these marked locations.

Those skilled in the art will readily observe that numerous modifications and alterations of the device may be made while retaining the teachings of the invention. Accordingly, the above disclosure should be construed as limited by the metes and bounds of the appended claims.

What is claimed is:

1. A method for weeding out commercials by searching for the existence of key segments at the time commercials are going to interrupt and resume a main program, comprising:
receiving an input source;
searching for a program interruption section and a program resumption section in the input source;
marking a plurality of key segments in the input source corresponding to the program interruption section and the program resumption section; and
finding a plurality of commercials between the key segments.

2. The method in claim 1, wherein the input source is a movie film.

3. The method in claim 1, wherein the input source is a television program.

4. The method in claim 1, wherein the program interruption section and the program resumption section are video frames.

5. The method in claim 1, wherein the program interruption section and the program resumption section are periods of sounds.

6. The method in claim 1, wherein the receiving step further comprises a step of providing a selective mode to users for searching for the program interruption section and the program resumption section.

7. The method in claim 1, wherein the finding step further comprises steps of executing a post-process procedure for the commercials and outputting a processed result.

8. The method in claim 7, wherein the post-process procedure is to store the commercials.

9. The method in claim 7, wherein the post-process procedure is to delete the commercials.

10. The method in claim 7, wherein the processed result is a commercial-free program.

11. The method in claim 1, wherein each commercial consists of a video portion and an audio portion.

12. A method for weeding out commercials by searching for the existence of key segments at the time the commercials are going to interrupt and resume a main program, comprising:
receiving an input source;
providing a selective mode to users;
searching for a program interruption section and a program resumption section in the input source according to the selective mode;
marking a plurality of key segments in the input source corresponding to the program interruption section and the program resumption section; and
finding a plurality of commercials between the key segments.

13. The method in claim 12, wherein the input source is a movie film.

14. The method in claim 12, wherein the input source is a television program.

15. The method in claim 12, wherein the program interruption section and the program resumption section are video frames.

16. The method in claim 12, wherein the program interruption section and the program resumption section are periods of sounds.

17. The method in claim 12, wherein the finding step further comprises steps of executing a post-process procedure for the commercials and outputting a processed result.

18. The method in claim 17, wherein the post-process procedure is to store the commercials.

19. The method in claim 17, wherein the post-process procedure is to delete the commercials.

20. The method in claim 17, wherein the processed result is a commercial-free program.

21. The method in claim 12, wherein each commercial consists of a video portion and an audio portion.

22. A method for weeding out commercials by searching for the existence of key segments at the time the commercials are going to interrupt and resume a main program, comprising:
receiving an input source;
setting flags for a program interruption section and a program resumption section;
marking a plurality of key segments in the input source corresponding to the flag of the program interruption section and the flag of the program resumption section; and
finding a plurality of commercials between the key segments.

23. The method in claim 22, wherein the input source is a movie film.

24. The method in claim 22, wherein the input source is a television program.

25. The method in claim 22, wherein the program interruption section and the program resumption section are video frames.

26. The method in claim 22, wherein the program interruption section and the program resumption section are periods of sounds.

27. The method in claim 22, wherein the receiving step further comprises a step of providing a selective mode to users for searching for the program interruption section and the program resumption section.

28. The method in claim 22, wherein the finding step further comprises steps of executing a post-process procedure for the commercials and outputting a processed result.

29. The method in claim 28, wherein the post-process procedure is to store the commercials.

30. The method in claim 28, wherein the post-process procedure is to delete the commercials.

31. The method in claim 28, wherein the processed result is a commercial-free program.

32. The method in claim 22, wherein each commercial consists of a video portion and an audio portion.

33. A method for weeding out commercials by searching for the existence of key segments at the time the commercials are going to interrupt and resume a main program, comprising:
receiving an input source;
providing a selective mode to users;
setting flags for a program interruption section and a program resumption section according to the selective mode;
marking a plurality of key segments in the input source corresponding to the flag of the program interruption section and the flag of the program resumption section; and
finding a plurality of commercials between the key segments.

34. The method in claim 33, wherein the input source is a movie film.

35. The method in claim 33, wherein the input source is a television program.

36. The method in claim 33, wherein the program interruption section and the program resumption section are video frames.

37. The method in claim 33, wherein the program interruption section and program resumption section are periods of sounds.

38. The method in claim 33, wherein the finding step further comprises steps of executing a post-process procedure for the commercials and outputting a processed result.

39. The method in claim 38, wherein the post-process procedure is to store the commercials.

40. The method in claim 38, wherein the post-process procedure is to delete the commercials.

41. The method in claim 38, wherein processed result is a commercial-free program.

42. The method in claim 33, wherein each commercial consists of a video portion and an audio portion.
